(19) United States
(12) Patent Application Publication
(10) Pub. No.: US 2025/0200089 A1
(43) Pub. Date: Jun. 19, 2025

(54) INFORMATION PROCESSING SYSTEM AND INFORMATION PROCESSING METHOD

(71) Applicant: Semiconductor Energy Laboratory Co., Ltd., Atsugi-shi (JP)

(72) Inventors: Junpei MOMO, Sagamihara (JP); Chizuko TANI, Ebina (JP)

(21) Appl. No.: 18/964,770

(22) Filed: Dec. 2, 2024

(30) Foreign Application Priority Data
Dec. 14, 2023 (JP) 2023-210955

(51) Int. Cl. G06F 16/334; G06F 40/268; G06F 40/40

(52) U.S. Cl. CPC G06F 16/3344; G06F 40/268; G06F 40/40

(57) ABSTRACT

A novel information processing system that is highly convenient, useful, or reliable is provided. The information processing system is composed of three components. A first component has a function of receiving a question document and providing an answer document. A second component receives a prompt, creates a draft answer with the use of a large language model, and transfers the draft answer to a third component. The third component creates a question document and obtains a search result from a database. The third component examines the draft answer on the basis of the search result and transfers the draft answer to the first component when the draft answer is true. The third component creates the answer document with the use of the search result and transfers the answer document when the draft answer is false. This system is intended to provide an appropriate answer to a question.

### BACKGROUND OF THE INVENTION

### 1. Field of the Invention

One embodiment of the present invention relates to an information processing system and an information processing method.

Note that one embodiment of the present invention is not limited to the above technical field. The technical field of one embodiment of the invention disclosed in this specification and the like relates to an object, a method, or a manufacturing method. One embodiment of the present invention relates to a process, a machine, manufacture, or a composition of matter. Specific examples of the technical field of one embodiment of the present invention disclosed in this specification include a semiconductor device, a display device, a light-emitting device, a power storage device, a storage device, a method of driving any of them, and a method of manufacturing any of them.

### 2. Description of the Related Art

In recent years, language models using neural networks have been actively developed, and especially large language models (LLM) have attracted attention. A large language model is a natural language processing model in which learning is performed using a massive amount of data. With a large language model, for example, a conversational model that gives an answer to a user's prompt can be achieved. In Non-Patent Document 1, generative pre-trained transformer 4 (GPT-4, registered trademark) is disclosed as a large language model, and ChatGPT is disclosed as a conversational model.

By utilizing a large language model, the capacity of a natural language processing model is significantly increased. On the other hand, it is difficult to incorporate and operate a language model at one's own facilities and expense due to the expansion of the language model. Accordingly, a language model provided by an external service is generally used.

### REFERENCE

### Non-Patent Document

[Non-Patent Document 1] Summary of ChatGPT/GPT-4 Research and Perspective Towards the Future of Large Language Models, Yiheng Liu et al., (submitted on 4 Apr. 2023) [online], Internet URL: https://arxiv.org/abs/2304.01852

### SUMMARY OF THE INVENTION

One object of one embodiment of the present invention is to provide a novel information processing system that is highly convenient, useful, or reliable. Another object is to provide a novel information processing method that is highly convenient, useful, or reliable. Another object is to provide a novel information processing system, a novel information processing method, or a novel semiconductor device.

Note that the description of these objects does not preclude the existence of other objects. In one embodiment of the present invention, there is no need to achieve all of these objects. Other objects will be apparent from and can be derived from the description of the specification, the drawings, the claims, and the like.

(1) One embodiment of the present invention is an information processing system including a first component, a second component, and a third component.

The first component has a function of receiving a question document and transferring the question document to the third component. The question document is written in a natural language. The first component has a function of receiving a first answer document and providing the first answer document.

The second component has a function of receiving a first prompt and transferring a draft answer to the third component. The second component has a function of executing processing using a large language model. The large language model has learned a data set. The large language model has a function of generating the draft answer in accordance with the first prompt.

The third component has a function of creating the first prompt and transferring the first prompt to the second component. The first prompt includes the question document. The third component has a function of executing processing using a search engine. The search engine has a function of obtaining a search result from a database with the use of the question document as a query. The database stores at least part of information that is not used in the data set.

The third component has a function of examining the draft answer with the use of the search result and generating an examination result. The third component has a function of, when the examination result is true, creating the first answer document with the use of the draft answer and transferring the first answer document to the first component.

The third component has a function of, when the examination result is false, creating the first answer document with the use of the search result and transferring the first answer document to the first component.

Accordingly, the information processing system of one embodiment of the present invention can evaluate the level of the possibility that information that is not based on the fact generated by the large language model (also referred to as hallucination) is included in the description of the first answer document. The information processing system of one embodiment of the present invention can determine whether or not the description of the first answer document is appropriate. The information processing system of one embodiment of the present invention can evaluate the credibility of the description of the first answer document. The information processing system of one embodiment of the present invention can examine the draft answer with the use of information that is not used in the data set used for learning of the large language model. The information processing system of one embodiment of the present invention can examine the draft answer with the use of information collected from the database using the question document as the query. The information processing system of one embodiment of the present invention can reflect the examination result in the first answer document. The information processing system of one embodiment of the present invention can ask for an answer with respect to the contents of the question document without determining whether or not the data set is appropriate. The information processing system of one embodiment of the present invention can use the large language model without unnecessary fine-tuning. The information processing system of one embodiment of the present invention can use the large language model without unnecessarily updating the data set and retraining the large language model. The information processing system of one embodiment of the present invention can use the large language model without the use of a retrieval augmented generation (RAG) method. The information processing system of one embodiment of the present invention does not need to include the search result in the first prompt; thus, the degree of freedom of the question document is high. As a result, a novel information processing system that is highly convenient, useful, or reliable can be provided.

(2) Another embodiment of the present invention is the information processing system in which the third component includes a morphological analyzer.

The morphological analyzer extracts morphemes from the draft answer and forms a first array. The morphological analyzer extracts morphemes from the search result and forms a second array.

The third component has a function of calculating a content ratio of the morphemes forming the second array to the morphemes forming the first array. The examination result is determined to be true or false on the basis of the content ratio.

(3) Another embodiment of the present invention is the above information processing system in which the third component has a function of converting the draft answer and the search result into distributed representations and calculating similarity. The examination result is determined to be true or false on the basis of the similarity.

(4) Another embodiment of the present invention is the above information processing system in which the third component includes a textual entailment recognition device.

The textual entailment recognition device has a function of determining whether or not textual entailment is established between the draft answer and the search result. The examination result is determined to be true or false on the basis of determination made by the textual entailment recognition device.

(5) Another embodiment of the present invention is the above information processing system in which the first component has a function of receiving a second answer document and providing the second answer document.

The second component has a function of receiving a second prompt and transferring the second answer document to the third component. The large language model has a function of generating the second answer document in accordance with the second prompt.

The third component has a function of, when the examination result is false, creating the second prompt and transferring the second prompt to the second component. The second prompt includes the question document and the search result. The third component has a function of receiving the second answer document and transferring the second answer document to the first component.

Accordingly, the information processing system of one embodiment of the present invention can generate the second answer document with the use of the retrieval augmented generation method when the large language model generates a hallucination. The information processing system of one embodiment of the present invention can prevent generation of the hallucination with the use of the retrieval augmented generation method. The information processing system of one embodiment of the present invention does not need to create the second prompt including the question document and the search result in the case where the retrieval augmented generation method is not used. The information processing system of one embodiment of the present invention allows an input of the question document with a high degree of freedom in the case where the retrieval augmented generation method is not used. As a result, a novel information processing system that is highly convenient, useful, or reliable can be provided.

(6) Another embodiment of the present invention is an information processing system including a first component, a second component, and a third component.

The first component has a function of receiving a question document and transferring the question document to the third component. The question document is written in a natural language. The first component has a function of receiving an answer document and providing the answer document.

The second component has a function of receiving a prompt and transferring a draft answer to the third component. The second component has a function of executing processing using a large language model. The large language model has learned a data set. The large language model has a function of generating the draft answer in accordance with the prompt.

The third component has a function of creating the prompt and transferring the prompt to the second component. The prompt includes the question document. The third component has a function of executing processing using a search engine. The search engine has a function of obtaining a search result from a database with the use of the draft answer as a query. The database stores at least part of information that is not used in the data set.

The third component has a function of examining the draft answer with the use of the search result and generating an examination result. The third component has a function of, when the examination result is true, creating the answer document with the use of the draft answer and transferring the answer document to the first component.

The third component has a function of, when the examination result is false, creating the answer document with the use of the search result and transferring the answer document to the first component.

Accordingly, the information processing system of one embodiment of the present invention can examine the draft answer with the use of information that is not used in the data set used for learning of the large language model. The information processing system of one embodiment of the present invention can examine the draft answer with the use of information collected from the database using the question document as the query. The information processing system of one embodiment of the present invention can examine the draft answer with the use of information collected from the database using the draft answer as the query. The information processing system of one embodiment of the present invention can reflect the examination result in the answer document. As a result, a novel information processing system that is highly convenient, useful, or reliable can be provided.

(7) Another embodiment of the present invention is an information processing method including a first step, a second step, a third step, a fourth step, a fifth step, a sixth step, a seventh step, an eighth step, and a ninth step.

In the first step, a first component receives a question document and transfers the question document to the second component.

In the second step, a second component creates a prompt and transfers the prompt to a third component. The prompt includes the question document.

In the third step, the third component receives the prompt and transfers a draft answer to the second component. The third component has a function of executing processing using a large language model. The large language model has learned a data set. The large language model has a function of generating the draft answer in accordance with the prompt.

In the fourth step, the second component obtains a search result from a database with the use of the question document as a query. The database stores at least part of information that is not used in the data set.

In the fifth step, the second component examines the draft answer with the use of the search result and generates an examination result.

In the sixth step, the process proceeds to the seventh step when the examination result is true, and the process proceeds to the eighth step when the examination result is false.

In the seventh step, the second component creates an answer document with the use of the draft answer and transfers the answer document to the first component, and then the process proceeds to the ninth step.

In the eighth step, the second component creates the answer document with the use of the search result and transfers the answer document to the first component, and then the process proceeds to the ninth step.

In the ninth step, the first component provides the answer document.

Accordingly, the information processing system of one embodiment of the present invention can evaluate the level of the possibility that the hallucination generated by the large language model is included in the description of the answer document. The information processing system of one embodiment of the present invention can determine whether or not the description of the answer document is appropriate. The information processing system of one embodiment of the present invention can evaluate the credibility of the description of the answer document. The information processing system of one embodiment of the present invention can examine the draft answer with the use of information that is not used in the data set used for learning of the large language model. The information processing system of one embodiment of the present invention can examine the draft answer with the use of information collected from the database using the question document as the query. The information processing system of one embodiment of the present invention can reflect the examination result in the answer document. The information processing system of one embodiment of the present invention can ask for an answer with respect to the contents of the question document without determining whether or not the data set is appropriate. The information processing system of one embodiment of the present invention can use the large language model without unnecessary fine-tuning. The information processing system of one embodiment of the present invention can use the large language model without unnecessarily updating the data set and retraining the large language model. The information processing system of one embodiment of the present invention can use the large language model without the use of the retrieval augmented generation method. The information processing system of one embodiment of the present invention does not need to include the search result in the prompt; thus, the degree of freedom of the question document is high. As a result, a novel information processing method that is highly convenient, useful, or reliable can be provided.

(8) Another embodiment of the present invention is an information processing method including a first step, a second step, a third step, a fourth step, a fifth step, a sixth step, a seventh step, an eighth step, and a ninth step.

In the first step, a first component receives a question document and transfers the question document to a second component.

In the second step, the second component creates a prompt and transfers the prompt to a third component. The prompt includes the question document.

In the third step, the third component receives the prompt and transfers a draft answer to the second component. The third component has a function of executing processing using a large language model. The large language model has learned a data set. The large language model has a function of generating the draft answer in accordance with the prompt.

In the fourth step, the second component obtains a search result from a database with the use of the draft answer as a query. The database stores at least part of information that is not used in the data set.

In the fifth step, the second component examines the draft answer with the use of the search result and generates an examination result.

In the sixth step, the process proceeds to the seventh step when the examination result is true, and the process proceeds to the eighth step when the examination result is false.

In the seventh step, the second component creates an answer document with the use of the draft answer and transfers the answer document to the first component, and then the process proceeds to the ninth step.

In the eighth step, the second component creates the answer document with the use of the search result and transfers the answer document to the first component, and then the process proceeds to the ninth step.

In the ninth step, the first component provides the answer document.

Accordingly, the draft answer can be examined with the use of information that is not used in the data set used for learning of the large language model. The draft answer can be examined with the use of information collected from the database using the question document as the query and information collected from the database using the draft answer as the query. The examination result can be expanded and reflected in the answer document. As a result, a novel information processing method that is highly convenient, useful, or reliable can be provided.

(9) Another embodiment of the present invention is an information processing method including a first step, a second step, a third step, a fourth step, a fifth step, a sixth step, a seventh step, an eighth step, a ninth step, a tenth step, and an eleventh step.

In the first step, a first component receives a question document and transfers the question document to a second component.

In the second step, the second component creates a first prompt and transfers the first prompt to a third component. The first prompt includes the question document.

In the third step, the third component receives the first prompt and transfers a draft answer to the second component. The third component has a function of executing processing using a large language model. The large language model has learned a data set. The large language model has a function of generating the draft answer in accordance with the first prompt.

In the fourth step, the second component obtains a search result from a database with the use of the question document as a query. The database stores at least part of information that is not used in the data set.

In the fifth step, the second component examines the draft answer with the use of the search result and generates an examination result.

In the sixth step, the process proceeds to the seventh step when the examination result is true, and the process proceeds to the eighth step when the examination result is false.

In the seventh step, the second component creates a first answer document with the use of the draft answer and transfers the first answer document to the first component, and then the process proceeds to the eleventh step.

In the eighth step, the second component creates the first answer document with the use of the search result and transfers the first answer document to the first component, and then creates a second prompt and transfers the second prompt to the third component. The second prompt includes the question document and the search result.

In the ninth step, the third component receives the second prompt and transfers a second answer document to the second component. The large language model has a function of generating the second answer document in accordance with the second prompt.

In the tenth step, the second component receives the second answer document and transfers the second answer document to the first component, and then the process proceeds to the eleventh step.

In the eleventh step, the first component provides the first answer document when the examination result is true, and provides the first answer document and the second answer document when the examination result is false.

Accordingly, the information processing system of one embodiment of the present invention can generate the second answer document with the use of the retrieval augmented generation method when the large language model generates a hallucination. The information processing system of one embodiment of the present invention can prevent generation of the hallucination with the use of the retrieval augmented generation method. The information processing system of one embodiment of the present invention does not need to create the second prompt including the question document and the search result in the case where the retrieval augmented generation method is not used. The information processing system of one embodiment of the present invention allows an input of the question document with a high degree of freedom in the case where the retrieval augmented generation method is not used. As a result, a novel information processing method that is highly convenient, useful, or reliable can be provided.

Although the block diagram in drawings attached to this specification shows components classified based on their functions in independent blocks, it is difficult to classify actual components based on their functions completely, and one component can have a plurality of functions.

One embodiment of the present invention can provide a novel information processing system that is highly convenient, useful, or reliable. Another embodiment of the present invention can provide a novel information processing method that is highly convenient, useful, or reliable. A novel information processing system can be provided. A novel information processing method can be provided.

Note that the description of these effects does not preclude the existence of other effects. One embodiment of the present invention does not necessarily have all these effects. Other effects will be apparent from and can be derived from the description of the specification, the drawings, the claims, and the like.

### BRIEF DESCRIPTION OF THE DRAWINGS

In the accompanying drawings:

FIG. 1 illustrates a structure of an information processing system of an embodiment;

FIG. 2 illustrates a structure of a prompt used in the information processing system of an embodiment;

FIG. 3 illustrates a structure of an information processing system of the embodiment;

FIG. 4 illustrates a structure of a prompt used in the information processing system of the embodiment;

FIG. 5 illustrates a structure of an information processing device used for the information processing system of the embodiment;

FIG. 6 illustrates an information processing method of an embodiment; and

FIG. 7 illustrates an information processing method of the embodiment.

### DETAILED DESCRIPTION OF THE INVENTION

An information processing system of one embodiment of the present invention includes a first component, a second component, and a third component. The first component has a function of receiving a question document and transferring the question document to the third component. The question document is written in a natural language. The first component has a function of receiving a first answer document and providing the first answer document. The second component has a function of receiving a first prompt and transferring a draft answer to the third component. The second component has a function of executing processing using a large language model. The large language model has learned a data set. The large language model has a function of generating the draft answer in accordance with the first prompt. The third component has a function of creating the first prompt and transferring the first prompt to the second component. The first prompt includes the question document. The third component has a function of executing processing using a search engine. The search engine has a function of obtaining a search result from a database with the use of the question document as a query. The database stores at least part of information that is not used in the data set. The third component has a function of examining the draft answer with the use of the search result and generating an examination result. The third component has a function of, when the examination result is true, creating the first answer document with the use of the draft answer and transferring the first answer document to the first component. The third component has a function of, when the examination result is false, creating the first answer document with the use of the search result and transferring the first answer document to the first component.

As a result, a novel information processing system that is highly convenient, useful, or reliable can be provided.

Embodiments will be described in detail with reference to the drawings. Note that the present invention is not limited to the following description, and it will be readily appreciated by those skilled in the art that modes and details of the present invention can be modified in various ways without departing from the spirit and scope of the present invention. Therefore, the present invention should not be construed as being limited to the description in the following embodiments. Note that in structures of the invention described below, the same portions or portions having similar functions are denoted by the same reference numerals in different drawings, and the description thereof is not repeated.

### Embodiment 1

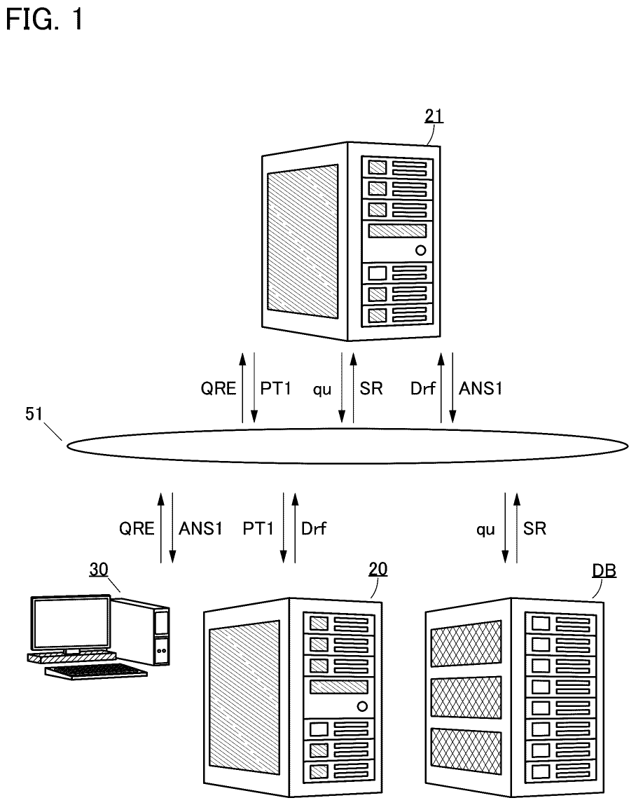

In this embodiment, a structure of an information processing system of one embodiment of the present invention is described with reference to FIG. 1 to FIG. 5.

FIG. 1 illustrates a structure of the information processing system of one embodiment of the present invention.

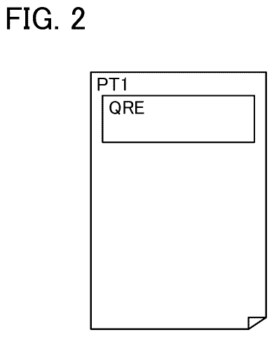

FIG. 2 is a schematic view illustrating a structure of a prompt used by the information processing system of one embodiment of the present invention.

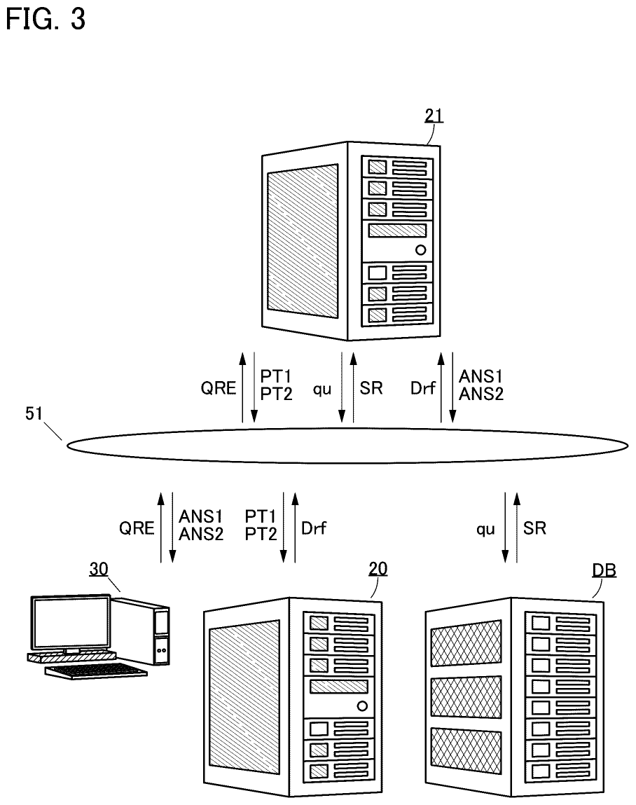

FIG. 3 illustrates a structure of the information processing system of one embodiment of the present invention.

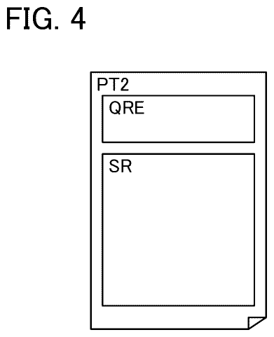

FIG. 4 is a schematic view illustrating a structure of a prompt used by the information processing system of one embodiment of the present invention.

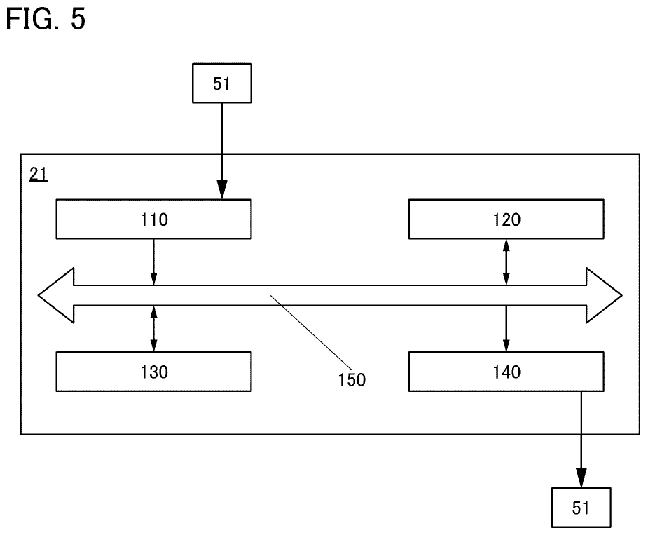

FIG. 5 is a block diagram illustrating a structure of an information processing device which can be used for the information processing system of one embodiment of the present invention.

### <<Structure Example 1 of Information Processing System>>

The information processing system described in this embodiment includes a component 30, a component 20, and a component 21 (see FIG. 1).

### <<Structure Example 1 of Component 30>>

The component 30 has a function of receiving a question document QRE and transferring the question document QRE to the component 21. Note that the question document QRE is written in a natural language.

The component 30 has a function of receiving an answer document ANS1 created by the component 21 and providing the answer document ANS1 to a user of the information processing system.

### <<Structure Example 1 of Component 20>>

The component 20 has a function of receiving a prompt PT1 created by the component 21 and transferring a draft answer Drf to the component 21.

The component 20 has a function of executing processing using a large language model LLM. Note that the large language model LLM has learned a data set DS.

The large language model LLM has a function of generating the draft answer Drf in accordance with the prompt PT1.

For example, BERT (Bidirectional Encoder Representations from Transformers), GPT-3, GPT-3.5, GPT-4 (registered trademark), LaMDA (Language Model for Dialogue Applications), PaLM (Pathways Language Model), Llama2, ALBERT, XLNet, or the like can be used as the large language model LLM.

### <<Structure Example 1 of Component 21>>

The component 21 has a function of creating the prompt PT1 and transferring the prompt PT1 to the component 20. Note that the prompt PT1 includes the question document QRE (see FIG. 2).

In addition, information specifying the range of a topic to which the question document QRE belongs can be included in the prompt PT1. Specifically, “politics,” “economics,” “culture,” “science,” “society,” “incident,” and the like can be used as information specifying the range of a topic. In addition, “natural science,” “technology and engineering,” “biology and agriculture,” “medicine, pharmacy, and psychology,” and the like can be used as information specifying the range of a topic. Furthermore, “materials science and engineering,” “architecture and architectural engineering,” “transportation engineering,” “energy engineering,” “computer science, telecommunication engineering, and electronic engineering,” “food engineering,” “military engineering,” “safety engineering and disaster,” and the like can be used as information specifying the range of a topic. Accordingly, the draft answer Drf including specialized information can be obtained.

In addition, information specifying the format of the draft answer Drf can be included in the prompt PT1. Specifically, expressions such as “answer like an expert,” “answer like a researcher,” and “answer like an engineer,” can be used as information specifying the format of the draft answer Drf can be used. Accordingly, the draft answer Drf making specialized logical strategy can be obtained.

The component 21 has a function of executing processing using a search engine SE. The search engine SE has a function of obtaining a search result SR from a database DB with the use of the question document QRE as a query qu. Note that the database DB stores at least part of information that is not used in the data set DS.

For example, an external search service that provides information on a website on the Internet can be used as the search engine SE and the database DB. Archived official documents or archived private documents can be used as the database DB. In addition, a database that manages confidential information or the like in an organization to which the user of the information processing system belongs can be used as the database DB.

The component 21 has a function of examining the draft answer Drf with the use of the search result SR and generating an examination result ER.

The component 21 has a function of creating the answer document ANS1 with the use of the draft answer Drf and transferring the answer document ANS1 to the component 30 when the examination result ER is true. The component 21 has a function of creating the answer document ANS1 with the use of the search result SR and transferring the answer document ANS1 to the component 30 when the examination result ER is false. Note that in the case where the answer document ANS1 is created with the use of the draft answer Drf, for example, the component 30 can display “This answer document is generated by AI. This answer document has been examined with the use of a search result.”. In the case where the answer document ANS1 is created with the use of the search result SR, for example, the component 30 can display “This answer document is created on the basis of a search result.”.

Accordingly, the information processing system of one embodiment of the present invention can evaluate the level of the possibility that a hallucination generated by the large language model LLM is included in the description of the answer document ANS1. The information processing system of one embodiment of the present invention can determine whether or not the description of the answer document ANS1 is appropriate. The information processing system of one embodiment of the present invention can evaluate the credibility of the description of the answer document ANS1. The information processing system of one embodiment of the present invention can examine the draft answer Drf with the use of information that is not used in the data set DS used for learning of the large language model LLM. The information processing system of one embodiment of the present invention can examine the draft answer Drf with the use of information collected from the database DB using the question document QRE as the query qu. The information processing system of one embodiment of the present invention can reflect the examination result ER in the answer document ANS1. The information processing system of one embodiment of the present invention can ask for an answer with respect to the contents of the question document QRE without determining whether or not the data set DS is appropriate. The information processing system of one embodiment of the present invention can use the large language model LLM without unnecessary fine-tuning. The information processing system of one embodiment of the present invention can use the large language model LLM without unnecessarily updating the data set DS and retraining the large language model LLM. The information processing system of one embodiment of the present invention can use the large language model LLM without the use of the retrieval augmented generation method. The information processing system of one embodiment of the present invention does not need to include the search result SR in the prompt PT1; thus, the degree of freedom of the question document QRE is high. As a result, a novel information processing system that is highly convenient, useful, or reliable can be provided.

### <<Structure Example 2 of Component 21>>

The component 21 includes a morphological analyzer MP_A. For example, “MeCab,” “Sudachi,” or the like can be used for the morphological analyzer MP_A. Specifically, even in a language where there is no clear delimiters between words, such as Japanese, words can be segmented. Furthermore, a part of speech of a word can be obtained. An appropriate part of speech such as a noun or an adjective can be selected. An appropriate phrase can be selected by bonding consecutive words.

Note that the morphological analyzer MP_A extracts morphemes from the draft answer Drf and forms an array AL1. Furthermore, the morphological analyzer MP_A extracts morphemes from the search result SR and forms an array AL2.

The component 21 has a function of calculating a content ratio CntR of the morphemes forming the array AL2 to the morphemes forming the array AL1, for example. The examination result ER is determined to be true or false on the basis of the content ratio CntR.

For example, the examination result ER can be set to be true when the content ratio CntR is higher than or equal to a predetermined value, and the examination result ER can be set to be false when the content ratio CntR is lower than the predetermined value. Specifically, the content ratio CntR is preferably higher than or equal to 0.9, further preferably 1. Note that when the content ratio CntR is 1, all of the morphemes extracted from the draft answer Drf are included in the morphemes extracted from the search result SR. Also, in the case where words and phrases extracted from the draft answer Drf are included in a synonym group of the words and phrases extracted from the search result SR, the words and phrases extracted from the draft answer Drf contributes to the content ratio CntR.

### <<Structure Example 3 of Component 21>>

The component 21 has a function of converting the draft answer Drf and the search result SR into distributed representations and calculating similarity SIM. For example, the draft answer Drf and a search result SR1 can be converted into the distributed representations with the use of the large language model. Specifically, the draft answer Drf and the search result SR1 can be converted into the distributed representations with the use of BERT, GPT-3, GPT-3.5, GPT-4 (registered trademark), LaMDA, PaLM, Llama2, ALBERT, XLNet, or the like. Note that when sentences are converted into distributed representations, semantic similarity can be found. Since the meaning of a sentence included in the draft answer Drf and the similarity of the meaning of a sentence included in the search result SR can be evaluated, inconsistencies in expressions due to a synonym or the like can be ignored. In particular, inconsistencies in verb expressions can be ignored.

The examination result ER is determined to be true or false on the basis of the similarity SIM.

For example, the examination result ER can be set to be true when cosine similarity is higher than or equal to a predetermined value, and the examination result ER can be set to be false when the cosine similarity is lower than the predetermined value. Specifically, the cosine similarity is preferably higher than or equal to 0.8.

### <<Structure Example 4 of Component 21>>

The component 21 includes a textual entailment recognition device RTE_A. For example, a large language model can be used for the textual entailment recognition device RTE_A. Specifically, BERT, GPT-3, GPT-3.5, GPT-4 (registered trademark), LaMDA, PaLM, Llama2, ALBERT, XLNet, or the like can be used as the textual entailment recognition device RTE_A. Note that the evaluation of the textual entailment recognition device most directly evaluates whether or not documents have the same meaning.

The textual entailment recognition device RTE_A has a function of determining whether or not a textual entailment is established between the draft answer Drf and the search result SR.

The examination result ER is determined to be true or false on the basis of the determination made by the textual entailment recognition device RTE_A.

### <Structure Example 2 of Information Processing System>

The information processing system described in this embodiment includes the component 30, the component 20, and the component 21 (see FIG. 3). Note that the structure example 2 of the information processing system described in this embodiment is different from the structure example 1 of the information processing system in that the component 20 is made to generate an answer document ANS2 with the use of a prompt PT2 including the question document QRE and the search result SR when the examination result of the draft answer Drf is false. Here, different parts will be described in detail, and the above description is referred to for similar parts.

### <<Structure Example 2 of Component 30>>

The component 30 has a function of receiving the answer document ANS2 created by the component 21 and providing the answer document ANS2 to the user of the information processing system.

### <<Structure Example 2 of Component 20>>

The component 20 has a function of receiving the prompt PT2 created by the component 21 and transferring the answer document ANS2 to the component 21. Note that the large language model LLM has a function of generating the answer document ANS2 in accordance with the prompt PT2.

### <<Structure Example 5 of Component 21>>

The component 21 has a function of, when the examination result ER is false, creating the prompt PT2 and transferring the prompt PT2 to the component 20. Note that the prompt PT2 includes the question document QRE and the search result SR (see FIG. 4). The prompt PT2 includes a request to answer the question document QRE with reference to the search result SR. Note that a method in which the prompt PT2 including the request to answer the question QRE with reference to the search result SR, the question document QRE, and the search result SR is used when the large language model LLM is made to generate the answer document ANS2 can be regarded to as one embodiment of the retrieval augmented generation method.

The component 21 has a function of receiving the answer document ANS2 generated by the component 20 and transferring the answer document ANS2 to the component 30. Note that in the case where the answer document ANS2 is an answer to the question document QRE with reference to the search result SR, for example, the component 30 can display “This answer is generated by AI with reference to the search result.”.

Accordingly, the information processing system of one embodiment of the present invention can generate the answer document ANS2 with the use of the retrieval augmented generation method when the large language model LLM generates a hallucination. The information processing system of one embodiment of the present invention can prevent generation of the hallucination with the use of the retrieval augmented generation method. The information processing system of one embodiment of the present invention does not need to create the prompt PT2 including the question document QRE and the search result SR in the case where the retrieval augmented generation method is not used. The information processing system of one embodiment of the present invention allows an input of the question document QRE with a high degree of freedom in the case where the retrieval augmented generation method is not used. As a result, a novel information processing system that is highly convenient, useful, or reliable can be provided.

For example, information on details of company's research and development is not included in the data set DS used for the learning of the large language model LLM. Thus, for example, the large language model LLM cannot always provide an appropriate answer to a question related to details of integrated circuit design. The retrieval augmented generation method gives reference information of an answer together with a question related to the details of integrated circuit design, and thus this method is useful.

In addition, the user of the information processing system asks various kinds of questions, which may include questions that can be answered without the retrieval augmented generation method or are not suitable for search. Thus, by evaluating an answer generated by the large language model with the use of the search result, a reliable answer can be obtained swiftly. Furthermore, an integrated circuit can be efficiently designed.

### <Structure Example 3 of Information Processing System>

A structure example 3 of the information processing system described in this embodiment is different from the structure examples 1 and 2 of the information processing system in that the search engine SE of the component 21 has a function of obtaining the search result SR from the database DB with the use of the draft answer Drf as the query qu. Here, different parts will be described in detail, and the above description is referred to for similar parts.

### <<Structure Example 6 of Component 21>>

The component 21 has a function of executing processing using the search engine SE. The search engine SE has a function of obtaining the search result SR from the database DB with the use of the draft answer Drf as the query qu. Note that the database DB stores at least part of information that is not used in the data set DS.

Thus, the information processing system of one embodiment of the present invention can examine the draft answer Drf with the use of information that is not used in the data set DS used for learning of the large language model LLM. The information processing system of one embodiment of the present invention can examine the draft answer Drf with the use of information collected from the database DB using the question document QRE as the query qu. The information processing system of one embodiment of the present invention can examine the draft answer Drf with the use of information collected from the database DB using the draft answer Drf as the query qu. The information processing system of one embodiment of the present invention can reflect the examination result ER in the answer document ANS1. As a result, a novel information processing system that is highly convenient, useful, or reliable can be provided.

### <Structure Example 4 of Information Processing System>

The information processing system described in this embodiment includes the component 30, the component 21, and the component 20 (see FIG. 1 or FIG. 3).

The information processing system of one embodiment of the present invention can be composed of an information processing device having a function of the component 30, an information processing device having a function of the component 21, and an information processing device having a function of the component 20, for example. Note that the information processing system of one embodiment of the present invention includes one or more information processing devices. For another example, the information processing system of one embodiment of the present invention can be composed of a plurality of information processing devices connected to each other through a network 51.

When the information processing system of one embodiment of the present invention is composed of a plurality of information processing devices, loads relating to information processing can be dispersed.

### <<Structure Example 1 of Information Processing Device>>

A structure example 1 of the information processing device described in this embodiment can be used as the component 30. The structure example 1 of the information processing device can be referred to as a client computer or the like. For example, a desktop computer can be used as the component 30.

The structure example 1 of the information processing device can receive data input by the user of the information processing system of one embodiment of the present invention. The structure example 1 of the information processing device can provide data output from the information processing system of one embodiment of the present invention to the user.

Dedicated application software, a web browser, or the like operates, for example. The user of the information processing system of one embodiment of the present invention can access the information processing system through the dedicated application software, the web browser, or the like. Thus, the user can enjoy a service using the information processing system of one embodiment of the present invention.

### <<Structure Example 2 of Information Processing Device>>

A structure example 2 of the information processing device described in this embodiment can be used as the component 21. For example, a workstation, a server computer, or a supercomputer can be used as the component 21.

The structure example 2 of the information processing device preferably has a function of a parallel computer. When the structure example 2 of the information processing device is used as a parallel computer, large-scale computation necessary for artificial intelligence (AI) learning and inference can be performed, for example.

Furthermore, the structure example 2 of the information processing device can execute processing using a natural language processing model using AI.

For example, the structure example 2 of the information processing device can execute natural language processing, which is processing using a natural language model such as BERT, Text-to-Text Transfer Transformer (T5), GPT-3, GPT-3.5, GPT-4, (registered trademark), LaMDA, PaLM, or Llama2.

### <<Structure Example 3 of Information Processing Device>>

A structure example 3 of the information processing device described in this embodiment can be used as the component 20, for example. Note that the component 20 has a larger scale and higher computational capability than the component 21. For example, a large computer such as a server computer or a supercomputer can be used as the component 20.

The structure example 3 of the information processing device preferably has a function of a parallel computer. When the structure example 3 of the information processing device is used as a parallel computer, large-scale computation necessary for AI learning and inference can be performed, for example.

Furthermore, the structure example 3 of the information processing device can execute processing using a natural language processing model using AI. In particular, the structure example 3 of the information processing device can execute processing using a general-purpose language processing model capable of performing a variety of natural language processing tasks.

For example, the structure example 3 of the information processing device can execute processing using a natural language model such as BERT, T5, GPT-3, GPT-3.5, GPT-4 (registered trademark), LaMDA, PaLM, or Llama2. In particular, the structure example 3 of the information processing device is preferably capable of executing processing using GPT-4 (registered trademark). For example, processing using a language model that is larger in scale than a conventional natural language model can achieve more natural text generation, interaction, or the like.

Note that a service provider using the information processing system of one embodiment of the present invention does not necessarily have its own structure example 3 of the information processing device. For example, a service provider can utilize part of the service that another company or the like provides using the structure example 3 of the information processing device.

### <<Structure Example of Network 51>>

The network 51 that can be used for the information processing system of one embodiment of the present invention can connect a plurality of information processing devices. Thus, the plurality of connected information processing devices can transmit and receive data to/from each other. In addition, a load related to information processing can be dispersed.

For wireless communication, it is possible to use, as a communication protocol or a communication technology, a communication standard such as the fourth-generation mobile communication system (4G), the fifth-generation mobile communication system (5G), or the sixth-generation mobile communication system (6G), or a communication standard developed by IEEE such as Wi-Fi (registered trademark) or Bluetooth (registered trademark).

For example, a local network can be used as the network 51. An intranet or an extranet can be used as the network 51. In addition, a network such as a personal area network (PAN), a local area network (LAN), a campus area network (CAN), a metropolitan area network (MAN), a wide area network (WAN), or a global area network (GAN) can be used as the network 51.

For another example, a global network can be used as the network 51. Specifically, the Internet, which is an infrastructure of the World Wide Web (WWW), can be used.

Furthermore, the service provider using the information processing system of one embodiment of the present invention can provide a service using the information processing method of one embodiment of the present invention through the network 51, for example.

Note that in the case where the information processing system of one embodiment of the present invention is constructed in a local network, the possibility of leaking confidential information can be lower than that in the case of using the Internet, for example.

### <<Structure Example 4 of Information Processing Device>>

The information processing device that can be used for the information processing system of one embodiment of the present invention includes an input unit 110, a storage unit 120, a processing unit 130, an output unit 140, and a transmission path 150, for example (see FIG. 5).

Although the block diagram in drawings attached to this specification shows components classified based on their functions in independent blocks, it is difficult to classify actual components based on their functions completely, and one component can have a plurality of functions. For example, part of the processing unit 130 functions as the input unit 110 in some cases. In addition, one function can be involved in a plurality of components. For example, processing executed by the processing unit 130 may be executed in different servers depending on the processing.

### [Input Unit 110]

The input unit 110 can receive data from the outside of the information processing device. For example, the input unit 110 receives data through the network 51. Specifically, a device such as a personal computer having a communication port or a communication function can be used.

The input unit 110 supplies received data to one or both of the storage unit 120 and the processing unit 130 through the transmission path 150.

### [Storage Unit 120]

The storage unit 120 has a function of storing a program to be executed by the processing unit 130. The storage unit 120 can have a function of storing data (e.g., an arithmetic result, an analysis result, and an inference result) generated by the processing unit 130, data received by the input unit 110, and the like.

The storage unit 120 can include a database. The information processing device can include another database in addition to the storage unit 120. The information processing device can have a function of extracting data from a database that is placed outside the storage unit 120, the information processing device, or the information processing system. Alternatively, the information processing device can have a function of extracting data from both of its own database and an external database.

One or both of a storage and a file server can be used as the storage unit 120. In addition, a database in which a path of a file stored in the file server is recorded can be used as the storage unit 120.

The storage unit 120 includes at least one of a volatile memory and a nonvolatile memory. Examples of the volatile memory include a dynamic random-access memory (DRAM) and a static random-access memory (SRAM). Examples of the nonvolatile memory include a resistive random-access memory (ReRAM, also referred to as a resistance-change memory), a phase-change random-access memory (PRAM), a ferroelectric random-access memory (FeRAM), a magnetoresistive random-access memory (MRAM, also referred to as a magnetoresistive memory), and a flash memory. The storage unit 120 can include at least one of a nonvolatile oxide semiconductor random-access memory (NOSRAM, registered trademark) and a dynamic oxide semiconductor random-access memory (DOSRAM, registered trademark). The storage unit 120 can include a recording media drive. Examples of the recording media drive include a hard disk drive (HDD) and a solid-state drive (SSD).

The NOSRAM is an abbreviation for a nonvolatile oxide semiconductor random-access memory (RAM). A NOSRAM is a memory in which a memory cell is a 2-transistor (2T) or 3-transistor (3T) gain cell and a transistor using a metal oxide in a channel formation region (also referred to as an OS transistor) is used. An OS transistor has an extremely low current that flows between a source and a drain in an off state, that is, an extremely low leakage current. The NOSRAM can be used as a nonvolatile memory by retaining electric charge corresponding to data in a memory cell, using characteristics of extremely low leakage current. In particular, the NOSRAM is capable of reading retained data without destruction (non-destructive reading), and thus is suitable for arithmetic processing in which only a data reading operation is repeated many times. Since the NOSRAM stacked over another component can have large data capacity, the performance of a semiconductor device can be increased by using the NOSRAM as a large cache memory, a main memory, or a storage memory.

The DOSRAM is an abbreviation for dynamic oxide semiconductor RAM, which indicates a RAM including one transistor (1T) and one capacitor (1C). The DOSRAM is a DRAM formed using an OS transistor, and a memory that temporarily stores information sent from the outside. The DOSRAM is a memory utilizing a low off-state current of the OS transistor.

In this specification and the like, a metal oxide means an oxide of metal in a broad sense. Metal oxides are classified into an oxide insulator, an oxide conductor (including a transparent oxide conductor), an oxide semiconductor (also simply referred to as an OS), and the like. For example, in the case where a metal oxide is used in a semiconductor layer of a transistor, the metal oxide is referred to as an oxide semiconductor in some cases.

The metal oxide included in the channel formation region preferably contains indium (In). When the metal oxide included in the channel formation region is a metal oxide containing indium, the carrier mobility (electron mobility) of the OS transistor is high. The metal oxide included in the channel formation region is preferably an oxide semiconductor containing an element M. The element M is preferably at least one of aluminum (Al), gallium (Ga), and tin (Sn). Other elements that can be used as the element M are boron (B), silicon (Si), titanium (Ti), iron (Fe), nickel (Ni), germanium (Ge), yttrium (Y), zirconium (Zr), molybdenum (Mo), lanthanum (La), cerium (Ce), neodymium (Nd), hafnium (Hf), tantalum (Ta), tungsten (W), and the like. Note that a combination of two or more of the above elements may be used as the element M. The element M is, for example, an element that has high bonding energy with oxygen. The element M is, for example, an element that has higher bonding energy with oxygen than indium does. The metal oxide included in the channel formation region is preferably a metal oxide containing zinc (Zn). The metal oxide containing zinc is easily crystallized in some cases.

The metal oxide included in the channel formation region is not limited to the metal oxide containing indium. The metal oxide in the channel formation region may be, for example, a metal oxide that does not contain indium and contains any of zinc, gallium, and tin, e.g., zinc tin oxide and gallium tin oxide.

### [Processing Unit 130]

The processing unit 130 has a function of executing processing such as arithmetic processing, analysis, and inference with the use of data supplied from one or both of the input unit 110 and the storage unit 120. The processing unit 130 can supply generated data (e.g., an arithmetic result, an analysis result, or an inference result) to one or both of the storage unit 120 and the output unit 140.

The processing unit 130 has a function of obtaining data from the storage unit 120. The processing unit 130 can have a function of recording or registering data in the storage unit 120.

The processing unit 130 can include an arithmetic circuit, for example. The processing unit 130 can include, for example, a central processing unit (CPU). The processing unit 130 can include a graphics processing unit (GPU).

The processing unit 130 can include a microprocessor such as a digital signal processor (DSP). The microprocessor can be obtained with a programmable logic device (PLD) such as a field programmable gate array (FPGA) or a field programmable analog array (FPAA). The processing unit 130 can include a quantum processor. The processing unit 130 can interpret and execute instructions from programs to process various kinds of data and control programs. The programs to be executed by the processor are stored in at least one of the storage unit 120 and a memory region of the processor.

The processing unit 130 can include a main memory. The main memory includes at least one of a volatile memory such as a RAM and a nonvolatile memory such as a read only memory (ROM). The main memory can include at least one of the above-described NOSRAM and DOSRAM.

For example, a DRAM, an SRAM, or the like is used as the RAM, a virtual memory space is assigned and utilized as a working space of the processing unit 130. An operating system, an application program, a program module, program data, a look-up table, and the like which are stored in the storage unit 120 are loaded into the RAM for execution. The data, program, and program module which are loaded into the RAM are each directly accessed and operated by the processing unit 130.

The ROM can store a basic input/output system (BIOS), firmware, and the like for which rewriting is not needed. Examples of the ROM include a mask ROM, a one-time programmable read only memory (OTPROM), and an erasable programmable read only memory (EPROM). Examples of the EPROM include an ultra-violet erasable programmable read only memory (UV-EPROM) which can erase stored data by irradiation with ultraviolet rays, an electrically erasable programmable read only memory (EEPROM), and a flash memory.

The processing unit 130 can include one or both of an OS transistor and a transistor including silicon in its channel formation region (Si transistor).

The processing unit 130 preferably includes an OS transistor. The OS transistor has an extremely low off-state current; therefore, with the use of the OS transistor as a switch for retaining electric charge (data) that has flowed into a capacitor functioning as a memory element, a long data retention period can be obtained. When at least one of a register and a cache memory included in the processing unit 130 has such a feature, the processing unit 130 can be operated only when needed, and otherwise can be off while data processed immediately before turning off the processing unit 130 is stored in the memory element. In other words, normally-off computing is possible and the power consumption of the information processing system can be reduced.

For at least part of the processing of the information processing device, AI is preferably used.

In particular, the information processing device preferably uses an artificial neural network (ANN; hereinafter just referred to as neural network in some cases). The neural network can be constructed with circuits (hardware) or programs (software).

In this specification and the like, the neural network indicates a general model having the capability of solving problems, which is modeled on a biological neural network and determines the connection strength of neurons by the learning. The neural network includes an input layer, a middle layer (hidden layer), and an output layer.

In the description of the neural network in this specification and the like, to determine a connection strength of neurons (also referred to as weight coefficient) from the existing information is referred to as “learning” in some cases.

In this specification and the like, to draw a new conclusion from a neural network formed with the connection strength obtained by learning is referred to as “inference” in some cases.

### [Output Unit 140]

The output unit 140 can output at least one of an arithmetic result, an analysis result, and an inference result in the processing unit 130 to the outside of the information processing device. For example, the output unit 140 can transmit data through the network 51. Specifically, a device such as a personal computer having a communication port and a communication function can be used. Furthermore, a device having a communication function may be used as the input unit 110 and the output unit 140.

### [Transmission Path 150]

The transmission path 150 has a function of transmitting data. Data transmission and reception among the input unit 110, the storage unit 120, the processing unit 130, and the output unit 140 can be performed through the transmission path 150. Specifically, a LAN or the Internet can be used.

Note that this embodiment can be combined with any of the other embodiments in this specification as appropriate.

### Embodiment 2

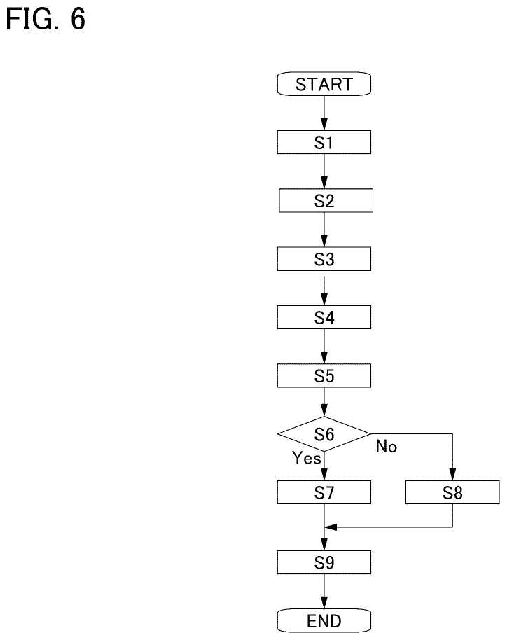

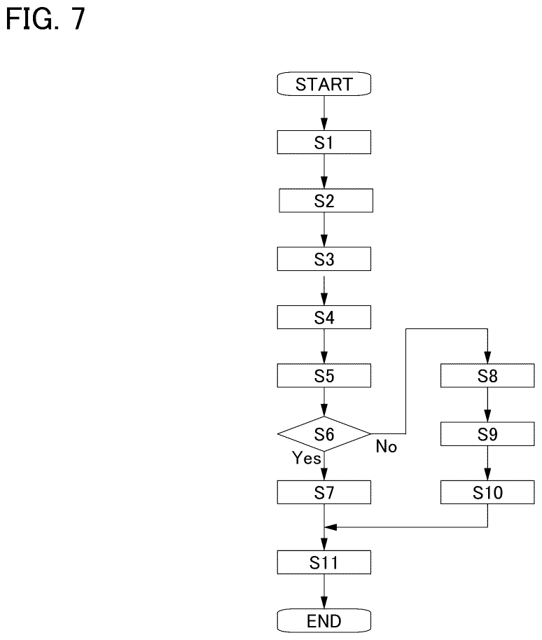

In this embodiment, an information processing method of one embodiment of the present invention will be described with reference to FIG. 6 and FIG. 7.

FIG. 6 illustrates the information processing method of one embodiment of the present invention.

FIG. 7 illustrates the information processing method of one embodiment of the present invention.

### <Example 1 of Information Processing Method>

The information processing method of one embodiment of the present invention includes Step S1 to Step S9 (see FIG. 6).

### [Step S1]

In an example 1 of the information processing method, in Step S1, the component 30 receives the question document QRE from a user of the information processing system and transfers the question document QRE to the component 21.

### [Step S2]

In Step S2, the component 21 creates the prompt PT1 and transfers the prompt PT1 to the component 20. Note that the prompt PT1 includes the question document QRE.

### [Step S3]

In Step S3, the component 20 receives the prompt PT1 and transfers the draft answer Drf to the component 21. Note that the component 20 has a function of executing processing using a large language model LLM. The large language model LLM has learned the data set DS and has a function of generating the draft answer Drf in accordance with the prompt PT1.

### [Step S4]

In Step S4, the component 21 obtains the search result SR from the database DB with the use of the question document QRE as the query qu. Note that the database DB stores at least part of information that is not used in the data set DS.

### [Step S5]

In Step S5, the component 21 examines the draft answer Drf with the use of the search result SR and generates the examination result ER.

### [Step S6]

In Step S6, the process proceeds to Step S7 when the examination result ER is true, and the process proceeds to Step S8 when the examination result ER is false.

### [Step S7]

In Step S7, the component 21 creates the answer document ANS1 with the use of the draft answer Drf. After the answer document ANS1 is transferred to the component 30, the process proceeds to Step S9.

### [Step S8]

In Step S8, the component 21 creates the answer document ANS1 with the use of the search result SR. After the answer document ANS1 is transferred to the component 30, the process proceeds to Step S9.

### [Step S9]

In Step S9, the component 30 provides the answer document ANS1 to the user of the information processing system.

Accordingly, the information processing system of one embodiment of the present invention can evaluate the level of the possibility that a hallucination generated by the large language model LLM is included in the description of the answer document ANS1. The information processing system of one embodiment of the present invention can determine whether or not the description of the answer document ANS1 is appropriate. The information processing system of one embodiment of the present invention can evaluate the credibility of the description of the answer document ANS1. The information processing system of one embodiment of the present invention can examine the draft answer Drf with the use of information that is not used in the data set DS used for learning of the large language model LLM. The information processing system of one embodiment of the present invention can examine the draft answer Drf with the use of information collected from the database DB using the question document QRE as the query qu. The information processing system of one embodiment of the present invention can reflect the examination result ER in the answer document ANS1. The information processing system of one embodiment of the present invention can ask for an answer with respect to the contents of the question document QRE without determining whether or not the data set DS is appropriate. The information processing system of one embodiment of the present invention can use the large language model without unnecessary fine-tuning. The information processing system of one embodiment of the present invention can use the large language model LLM without unnecessarily updating the data set DS and retraining the large language model LLM. The information processing system of one embodiment of the present invention can use the large language model LLM without the use of the retrieval augmented generation method. The information processing system of one embodiment of the present invention does not need to include the search result SR in the prompt PT1; thus, the degree of freedom of the question document QRE is high. As a result, a novel information processing method that is highly convenient, useful, or reliable can be provided.

### <Example 2 of Information Processing Method>

The information processing method of one embodiment of the present invention includes Steps S1 to S9 (see FIG. 6). Note that an example 2 of the information processing method described in this embodiment is different from the example 1 of the information processing method in that when the component 21 obtains the search result SR from the database DB, not the question document QRE but the draft answer Drf is used as the query qu in Step S4. Here, different parts will be described in detail, and the above description is referred to for similar parts.

### [Step S4]

In Step S4, the component 21 obtains the search result SR from the database DB with the use of the draft answer Drf as the query qu. Note that the database DB stores at least part of information that is not used in the data set DS.

Accordingly, the information processing system of one embodiment of the present invention can examine the draft answer Drf with the use of information that is not used in the data set DS used for learning of the large language model LLM. The information processing system of one embodiment of the present invention can examine the draft answer Drf with the use of information collected from the database DB using the question document QRE as the query qu and information collected from the database DB using the draft answer Drf as the query qu. The information processing system of one embodiment of the present invention can expand the examination result ER and reflect the examination result ER in the answer document ANS1. As a result, a novel information processing method that is highly convenient, useful, or reliable can be provided.

### <Example 3 of Information Processing Method>

The information processing method of one embodiment of the present invention includes Steps S1 to S11 (see FIG. 7). Note that an example 3 of the information processing method described in this embodiment is different from the examples 1 and 2 of the information processing method in an information processing step in a case where the examination result ER is determined to be false in Step S6. Here, different parts will be described in detail, and the above description is referred to for similar parts.

### [Step S1]

In Step S1, the component 30 receives the question document QRE from a user of the information processing system and transfers the question document QRE to the component 21.

### [Step S2]

In Step S2, the component 21 creates the prompt PT1 and transfers the prompt PT1 to the component 20. Note that the prompt PT1 includes the question document QRE.

### [Step S3]

In Step S3, the component 20 receives the prompt PT1 and transfers the draft answer Drf to the component 21. Note that the component 20 has a function of executing processing using a large language model LLM. The large language model LLM has learned the data set DS and has a function of generating the draft answer Drf in accordance with the prompt PT1.

### [Step S4]

In Step S4, the component 21 obtains the search result SR from the database DB with the use of the question document QRE as the query qu. Note that the database DB stores at least part of information that is not used in the data set DS.

### [Step S5]

In Step S5, the component 21 examines the draft answer Drf with the use of the search result SR and generates the examination result ER.

### [Step S6]

In Step S6, the process proceeds to Step S7 when the examination result ER is true, and the process proceeds to Step S8 when the examination result ER is false.

### [Step S7]

In Step S7, the component 21 creates the answer document ANS1 with the use of the draft answer Drf. After the answer document ANS1 is transferred to the component 30, the process proceeds to Step S11.

### [Step S8]

In Step S8, the component 21 creates the answer document ANS1 with the use of the search result SR and transfers the answer ANS1 to the component 30. The component 21 creates the prompt PT2 and transfers the prompt PT2 to the component 20. Note that the prompt PT2 includes the question document QRE and the search result SR.

### [Step S9]

In Step S9, the component 20 receives the prompt PT2 and transfers the answer document ANS2 to the component 21. Note that the component 20 has a function of executing processing using the large language model LLM, and the large language model LLM has a function of generating the answer document ANS2 in accordance with the prompt PT2.

### [Step S10]

In Step S10, the component 21 receives the answer document ANS2 and transfers the answer document ANS2 to the component 30, and then the process proceeds to Step S11.

### [Step S11]

In Step S11, the component 30 provides the answer document ANS1 to the user of the information processing system when the examination result ER is true. The component 30 provides the answer document ANS1 and the answer document ANS2 to the user of the information processing system when the examination result ER is false.

Accordingly, the information processing system of one embodiment of the present invention can generate the answer document ANS2 with the use of the retrieval augmented generation method when the large language model LLM generates the hallucination. The information processing system of one embodiment of the present invention can prevent generation of the hallucination with the use of the retrieval augmented generation method. The information processing system of one embodiment of the present invention does not need to create the prompt PT2 including the question document QRE and the search result SR in the case where the retrieval augmented generation method is not used. The information processing system of one embodiment of the present invention allows an input of the question document QRE with a high degree of freedom in the case where the retrieval augmented generation method is not used. As a result, a novel information processing method that is highly convenient, useful, or reliable can be provided.

Note that this embodiment can be combined with any of the other embodiments in this specification as appropriate.

This application is based on Japanese Patent Application Serial No. 2023-210955 filed with Japan Patent Office on Dec. 14, 2023, the entire contents of which are hereby incorporated by reference.

What is claimed is:

1. An information processing system comprising:
a first component;
a second component; and
a third component,
wherein the first component is configured to receive a question document and transfer the question document to the third component,
wherein the question document is written in a natural language,
wherein the first component is configured to receive an answer document and provide the first answer document,
wherein the second component is configured to receive a first prompt and transfer a draft answer to the third component,
wherein the second component is configured to execute processing using a large language model,
wherein the large language model has learned a data set,
wherein the large language model is configured to generate the draft answer in accordance with the first prompt,
wherein the third component is configured to create the first prompt and transfer the first prompt to the second component,
wherein the first prompt comprises the question document,
wherein the third component is configured to execute processing using a search engine,
wherein the search engine is configured to obtain a search result from a database with use of the question document or the draft answer as a query,
wherein the database stores at least part of information not used in the data set,
wherein the third component is configured to examine the draft answer with use of the search result and generate an examination result,
wherein the third component is configured to, when the examination result is true, create the first answer document with use of the draft answer and transfer the first answer document to the first component, and
wherein the third component is configured to, when the examination result is false, create the first answer document with use of the search result and transfer the first answer document to the first component.

2. The information processing system according to claim 1,
wherein the third component comprises a morphological analyzer,
wherein the morphological analyzer is configured to extract morphemes from the draft answer and to form a first array,
wherein the morphological analyzer is configured to extract morphemes from the search result and to form a second array,
wherein the third component is configured to calculate a content ratio of the morphemes forming the second array to the morphemes forming the first array, and
wherein the examination result is determined to be true or false on the basis of the content ratio.

3. The information processing system according to claim 1,
wherein the third component is configured to convert the draft answer and the search result into distributed representations and calculating similarity, and
wherein the examination result is determined to be true or false on the basis of the similarity.

4. The information processing system according to claim 1,
wherein the third component comprises a textual entailment recognition device,
wherein the textual entailment recognition device is configured to determine whether or not textual entailment is established between the draft answer and the search result, and
wherein the examination result is determined to be true or false on the basis of a determination made by the textual entailment recognition device.

5. The information processing system according to claim 1,
wherein the first component is configured to receive a second answer document and provide the second answer document,
wherein the second component is configured to receive a second prompt and transfer the second answer document to the third component,
wherein the large language model is configured to generate the second answer document in accordance with the second prompt,
wherein the third component is configured to, when the examination result is false, create the second prompt and transfer the second prompt to the second component,
wherein the second prompt comprises the question document and the search result, and
wherein the third component is configured to receive the second answer document and transfer the second answer document to the first component.

6. An information processing method comprising a first step, a second step, a third step, a fourth step, a fifth step, a sixth step, a seventh step, an eighth step, and a ninth step,
wherein in the first step, a first component receives a question document and transfers the question document to a second component,
wherein in the second step, the second component creates a prompt and transfers the prompt to a third component,
wherein the prompt comprises the question document,
wherein in the third step, the third component receives the prompt and transfers a draft answer to the second component,
wherein the third component is configured to execute processing using a large language model,
wherein the large language model has learned a data set,
wherein the large language model is configured to generate the draft answer in accordance with the prompt,
wherein in the fourth step, the second component obtains a search result from a database with use of the question document or the draft answer as a query,
wherein the database stores at least part of information not used in the data set,
wherein in the fifth step, the second component examines the draft answer with use of the search result and generates an examination result,
wherein in the sixth step, the process proceeds to the seventh step when the examination result is true, and the process proceeds to the eighth step when the examination result is false,
wherein in the seventh step, the second component creates an answer document with use of the draft answer and transfers the answer document to the first component, and then the process proceeds to the ninth step,
wherein in the eighth step, the second component creates the answer document with use of the search result and transfers the answer document to the first component, and then the process proceeds to the ninth step, and
wherein in the ninth step, the first component provides the answer document.

7. An information processing method comprising a first step, a second step, a third step, a fourth step, a fifth step, a sixth step, a seventh step, an eighth step, a ninth step, a tenth step, and an eleventh step,
wherein in the first step, a first component receives a question document and transfers the question document to a second component,
wherein in the second step, the second component creates a first prompt and transfers the first prompt to a third component,
wherein the first prompt comprises the question document,
wherein in the third step, the third component receives the first prompt and transfers a draft answer to the second component,
wherein the third component is configured to execute processing using a large language model,
wherein the large language model has learned a data set,
wherein the large language model is configured to generate the draft answer in accordance with the first prompt,
wherein in the fourth step, the second component obtains a search result from a database with use of the question document as a query,
wherein the database stores at least part of information not used in the data set,
wherein in the fifth step, the second component examines the draft answer with use of the search result and generates an examination result,
wherein in the sixth step, the process proceeds to the seventh step when the examination result is true, and the process proceeds to the eighth step when the examination result is false,
wherein in the seventh step, the second component creates a first answer document with use of the draft answer and transfers the first answer document to the first component, and then the process proceeds to the eleventh step,
wherein in the eighth step, the second component creates the first answer document with use of the search result and transfers the first answer document to the first component, and then creates a second prompt and transfers the second prompt to the third component,
wherein the second prompt comprises the question document and the search result,
wherein in the ninth step, the third component receives the second prompt and transfers a second answer document to the second component,
wherein the large language model is configured to generate the second answer document in accordance with the second prompt,
wherein in the tenth step, the second component receives the second answer document and transfers the second answer document to the first component, and then the process proceeds to the eleventh step, and
wherein in the eleventh step, the first component provides the first answer document when the examination result is true, and provides the first answer document and the second answer document when the examination result is false.
